(19) United States
(12) Patent Application Publication
(10) Pub. No.: US 2013/0291874 A1
(43) Pub. Date: Nov. 7, 2013

(54) AWE JAW MOUTH PIECE/DEVICE

(71) Applicant: Andrew W. Engel, Bend, OR (US)

(72) Inventor: Andrew W. Engel, Bend, OR (US)

(21) Appl. No.: 13/465,539

(22) Filed: May 7, 2012

(51) Int. Cl. A61C 5/14

(52) U.S. Cl. 128/861

(57) ABSTRACT

A dental guard has a first portion which is molded or shaped to conform to the teeth of either one of the upper or lower jaw, a second portion which is a resilient material having passages therethrough to permit passage of air, and a third portion adapted for contact with the other one of the upper or lower jaw. The dental guard provides enhanced TMJ stability, protects teeth, allows air flow for breathing, protects the airway from foreign objects, and allows compression in case of impact or necessity of swallowing.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to an jaw mouth piece/device, particularly for use as a mouthguard with an enlarged protective material permitting flow through of air for facilitating breathing.

### BACKGROUND OF THE INVENTION

Mouthguards are known for protecting the jaw and teeth during athletic activities. Such mouthguards employ a resilient material for separating the upper and lower jaws so that an impact reduces potential damage to the teeth and the jaws.

Dental night guards are also known in the art. These types of mouthguards are intended to prevent wear and breakage of teeth from grinding. In use, a member is molded or otherwise fitted to either the upper set of teeth or the lower set of teeth.

However, for use in athletic activities, it is desirable to provide a substantial amount of cushioning material between the upper and lower jaws, yet too much such material would interfere with breathing and thereby may reduce the athletic effectiveness of the athlete. It is therefore a problem in the art to provide a mouth guard which provides a substantial amount of cushioning material between the jaws so as to protect the teeth and jaws without obstructing breathing of the wearer.

### SUMMARY OF THE INVENTION

From the foregoing, it is seen that it is a problem in the art to provide a device meeting the above requirements. According to the present invention, a device is provided which meets the aforementioned requirements and needs in the prior art.

Specifically, the device according to the present invention provides a mouth guard having a substantial amount of cushioning material between the upper and lower jaws to protect a wearer such as an athlete, yet permitting airflow so as to protect the jaws without obstructing breathing of the wearer.

The device of the present invention provides a unique invention which has a first portion which is a molded or shaped portion which conforms to the teeth of either one of the upper or lower jaw, a second portion which is a resilient material having passages therethrough to permit passage of air, and a third portion adapted for contact with the other one of the upper or lower jaw.

The device of the present invention also provides enhanced temporomandibular joint (hereafter referred to as “TMJ”) stability, protects teeth, allows air flow for breathing, protects the airway from foreign objects, and allows compression in case of impact or necessity of swallowing. The device of the present invention is moldable to conform to teeth in individuals, can come in different sizes, and can optionally be reinforced by use of titanium wire, and can optionally be internally tensioned by use of interior structural components.

The device of the present invention has additional features and advantages. By providing TMJ stability, it deactivates nerves and muscles aiding in more cognitive functions. The airway of the user remains unobstructed and airflow is significantly improved. The device of the present invention also permits increases oxygen and carbon dioxide exchange, and also aids in opening posterior soft tissue of the soft palate. The device of the present invention therefore finds use in football and all similar sports with all age groups, military, racing both motor and personal powered, dental market with TMJ and sleep apnea or snoring, among others.

Other objects and advantages of the present invention will be more readily apparent from the following detailed description when read in conjunction with the accompanying drawings.

### BRIEF DESCRIPTION OF THE DRAWINGS

FIG. 1 is a top elevational view of the dental guard according to the present invention.

FIG. 2 is a bottom elevational view of the dental guard according to the present invention.

FIG. 3 is a side elevational view of the dental guard according to the present invention.

FIG. 4 front elevational view of the dental guard according to the present invention.

FIG. 5 is an enlarged, schematic elevational view of a portion of inner mesh forming a middle portion of the dental guard of FIGS. 1-4, according to the present invention.

FIG. 6 is a perspective view from the rear of the dental guard of FIGS. 1-4, according to the present invention.

FIG. 7 is an exploded view of the parts of the dental guard of FIGS. 1-4 and 6.

FIG. 8 is a top elevational view of two walls forming the middle portion of the device of FIGS. 1-4, 6, and 7.

FIG. 9 is a top elevational view of an alternative embodiment of the middle portion of the device of FIG. 1, formed as a single body.

FIG. 10 is a side elevational view of the alternative embodiment of the middle portion of the device shown in FIG. 9, as viewed from the right of FIG. 9.

FIG. 11 is a sectional view of the solid body of FIG. 9, taken along line 11-11 of FIG. 9.

### DETAILED DESCRIPTION OF THE INVENTION

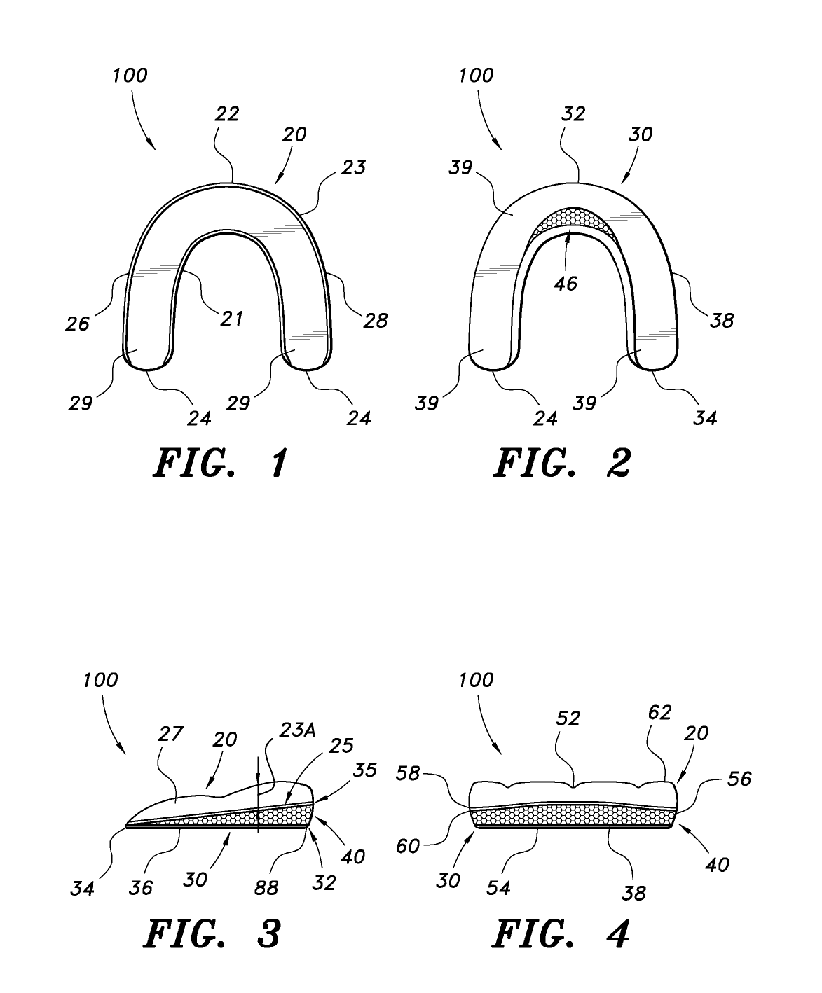

FIG. 1 is a top elevational view of a dental guard 100 according to the present invention. The dental guard 100 includes a top portion which is referred to hereafter as a first portion 20. The first portion 20 is preferably a molded portion formed of resilient material of any of the types which are known for dental or oral use.

The first portion 20 has a raised inner wall 21 and a raised outer wall 22. The first portion 20 includes an anterior portion 23, a posterior portion 24 which is bilateral, a lateral portion 26 a raised lip for vestibule 28, and an upper occlusal area 29.

The device of the present invention provides a unique invention which has the first portion 20 which is a molded or shaped portion which conforms to the teeth of either one of the upper or lower jaw, the second portion 40 which is a resilient material having passages therethrough to permit passage of air, and the third portion 30 adapted for contact with the other one of the upper or lower jaw. The device of the present invention also provides enhanced temporomandibular joint (hereafter referred to as “TMJ”) stability, protects teeth, allows air flow for breathing, protects the airway from foreign objects, and allows compression in case of impact or necessity of swallowing. The device of the present invention is moldable to conform to teeth in individuals, can come in different sizes, and can optionally be reinforced by use of titanium wire, and can optionally be internally tensioned by use of interior structural components.

The device of the present invention has additional features and advantages. By providing TMJ stability, it deactivates nerves and muscles aiding in more cognitive functions. The airway of the user remains unobstructed and airflow is significantly improved. The device of the present invention also permits increases oxygen and carbon dioxide exchange, and also aids in opening posterior soft tissue of the soft palate. The device of the present invention therefore finds use in football and all similar sports with all age groups, military, racing both motor and personal powered, dental market with TMJ and sleep apnea or snoring, among others.

In the following, it will be understood that different types of materials can be used, and different types of fastening means and securing means can be used. All such variations would be within the ambit of skill of anyone having skill in the dental arts, and all such variations are contemplated as being within the scope of the present invention.

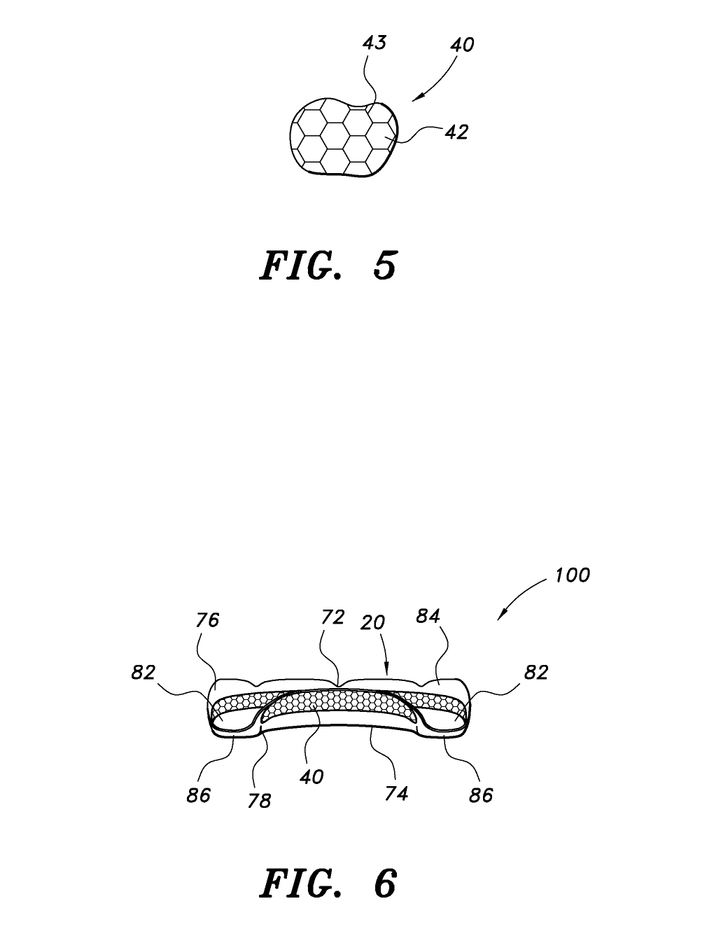

FIG. 2 is a bottom elevational view of the dental guard 100 of FIG. 1, and shows the first portion 20, a second portion 40, and a third portion 30. The first portion 20 is adapted to fit over the teeth of either one of an upper jaw or a lower jaw. The second portion 40 has an inner wall 46 which is an inner mesh having a plurality of air passages therethrough, as also discussed further hereunder with regard to FIG. 5.

As shown in FIG. 2, the third portion 30 has an anterior portion 32, a posterior portion 34, a lateral border 38, and a lower occlusal area 39. The third portion 30 is formed as a generally flat member which protects the second portion 40 from the teeth of the other jaw which is not covered by the first portion 20. The third portion 30 is preferably formed of material of any of the types which are known for dental or oral use, and adapted for contact with teeth.

FIG. 3 is a side elevational view of the dental guard 100 of FIGS. 1 and 2. In this view, the first portion 20, the second portion 40, and the third portion 30 are seen from the right hand side of FIG. 1. As shown in FIG. 3, the first portion 20 has a wall height 23A of the upper raised lip 23, a bottom wall portion 25, a superior lateral portion 27, an anterior portion 32, a posterior portion 34, a solid upper occlusal area 35, an inferior lateral position 36, and a solid lower occlusal area 88.

FIG. 4 front elevational view of the dental guard 100 of FIGS. 1-3, showing the first portion 20, the second portion 40, and the third portion 30 in front view. The first portion 20 has an upper occlusal area 58, a superior anterior border 52, and an upper raised lip area 62. The second portion 40 has a front wall portion 41 formed of a honeycomb mesh 56. The third portion 30 has an interior anterior border 54, and a lower occlusal area 60.

FIG. 5 is an enlarged, schematic elevational view of a mesh wall of the second portion 40 having a plurality of hollow tubular members having wall portions 43 having hollow interior portions 42. The second portion 40 shown in FIG. 5 is in a honeycomb pattern. The mesh wall of FIG. 5 is the material that forms the inner mesh wall 46 and the front wall portion 41 of the second portion 40. The wall portions 43 are preferably composed of a flexible resilient material that is compressible upon pressure. The hollow interior portions 42 are preferably formed as the open center portions of hexagons to allow air passage therethrough.

FIG. 6 is a perspective view from the top rear of the dental guard 100 of FIGS. 1-4. The numbered parts that correspond to those shown in the previous figures are as described above. The dental guard 100 of FIG. 6 has a superior border 72, an inferior border 74, a lateral border 76, a lateral border 78, an upper occlusal area 82, an upper raised lip 84, and a posterior border 86.

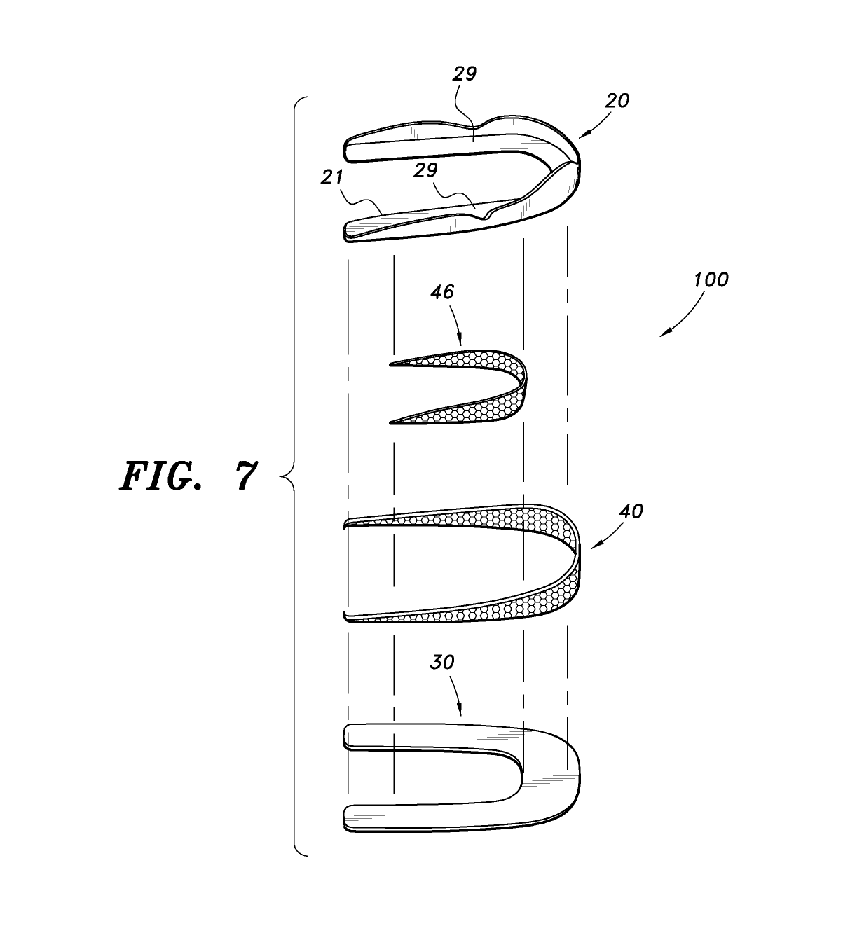

FIG. 7 is a schematic, exploded view of the parts of the dental guard of FIGS. 1-6. The numbered parts correspond to those discussed hereinabove with respect to FIGS. 1-6. The inner wall 21 has been omitted from the top portion 20 for the sake of clarity, so that the area 29 can be more clearly seen. The portions 40 and 46 shown in FIG. 7 can be sufficiently strong to separate the portions 20 and 30 when in use; this can be done by providing sufficient thickness of the portions 40 and 46, and/or by providing reinforcing elements such as titanium wire and/or other structural reinforcing materials known to any one having skill in the dental arts.

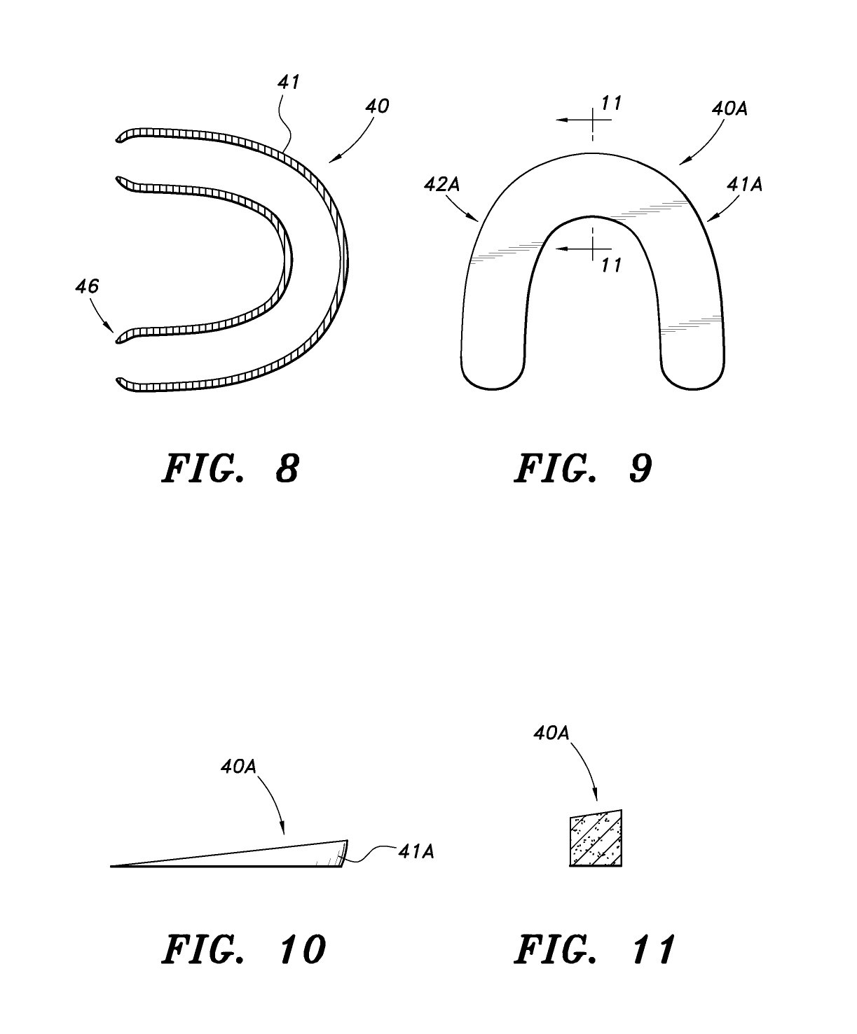

FIG. 8 is a top elevational view of two walls 41 and 46 forming the second portion 40 of the central body portion dental guard 100 FIGS. 1-7 discussed hereinabove. The wall 41 is smaller than the wall 46, the walls 41 and 46—together with the lowermost wall of the first portion 20 and the uppermost surface of the third portion 30—the forming an enclosed region through which air can flow. The thin honeycomb mesh of the walls 41 and 46 of the second portion 40 preventing entry of debris while permitting flow of air therethrough and permitting the flow of fluids therethrough for example saliva when in use or water when the dental guard 100 is rinsed or washed.

FIG. 9 is a top elevational view of an alternative embodiment 40A of the middle portion of the dental guard 100 of FIG. 1, formed as a single body formed of a porous material, preferably a honeycomb material of the type shown and described in FIG. 5. The honeycomb material can be formed from a plurality of tubular elements having hexagonal shaped wall portions respectively bounding central air passages to permit the passage of air.

FIG. 10 is a side elevational view of the alternative embodiment 40A of the middle portion of the dental guard 100 shown in FIG. 9, as viewed from the right of FIG. 9.

FIG. 11 is a sectional view of the solid body 40A of FIG. 9, taken along line 11-11 of FIG. 9.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A dental guard, comprising:
a first portion which is molded or shaped to conform to the teeth of either one of the upper or lower jaw,
a second portion which is a resilient material having passages therethrough to permit passage of air, and
a third portion adapted for contact with the other one of the upper or lower jaw.

2. The device of claim 1, wherein said second portion is composed of closely packed hollow tubular members adapted to permit passage of air therethrough.

3. The device of claim 2, wherein said hollow tubular members have walls with a hexagonal shape.

4. The device of claim 1 wherein at least one of the first portion and the third portion is reinforced by use of titanium wire.

5. The device of claim 1 wherein at least one of the first portion and the third portion is reinforced by use of titanium wire, and at least one of the first portion and the third portion includes is internally tensioned.

6. The device of claim 1 wherein said second portion has a honeycomb structure with hexagonal walls bounding air passages to permit flow of air.

7. The device of claim 1, wherein said second portion comprises a thin curved member.

8. The device of claim 7, where in said thin curved member has a curved shape having a longitudinal extend and a transverse extent which represents a height, and wherein said thin curved member includes opposed end portions and a mid-portion, wherein the mid-portion has a greater height than that of the opposed end portions.

9. The device of claim 1, wherein said second portion comprises a wedge-shaped body formed of a plurality of tubular elements having hexagonal shaped wall portions respectively bounding central air passages to permit the passage of air.
